(19) United States
(12) Patent Application Publication
(10) Pub. No.: US 2016/0052580 A1
(43) Pub. Date: Feb. 25, 2016

(54) Bike Transport Handle

(71) Applicant: Carl Salvo, Council Bluffs, IA (US)

(72) Inventor: Carl Salvo, Council Bluffs, IA (US)

(21) Appl. No.: 14/810,966

(22) Filed: Jul. 28, 2015

Related U.S. Application Data
(60) Provisional application No. 62/041,207, filed on Aug. 25, 2014.

(51) Int. Cl. B62J 7/00

(52) U.S. Cl. CPC B62J 7/00; B62J 2300/0053

(57) ABSTRACT

A bike transport handle is described for improving a person's ability to lift a bike for transporting. The bike transport handle comprises an attachment plate, a grasping plate, a stabilizing portion, and a grip. The bike transport handle may be attached to a bike's down tube or seat tube through apertures on the attachment plate.

### CROSS-REFERENCE TO PRIORITY/PROVISIONAL APPLICATIONS

This application claims priority under 35 U.S.C. §119 of U.S. Provisional Application No. 62/041,207, filed Aug. 25, 2014, which is expressly incorporated by reference in its entirety.

### BACKGROUND

Bicycles (i.e., bikes) are a common form of transportation, whether a person wants to travel just a short distance around the neighborhood, or whether a person wants to use the bike for more rigorous activity, such as when traveling longer distances or when riding off road (e.g., on bike trails, hills, etc.). Thus, bikes must be designed to be sufficiently sturdy, so as to properly support the rider of the bike and to be able to withstand the wear and tear of such activities.

Bicyclists encounter a variety of obstacles in transporting their bikes from point to point. For instance, a bicyclist may encounter terrain that requires him or her to stop riding and to carry his or her bike because walking over the terrain is safer than attempting to ride over it (e.g., navigating up a rocky path on a trail). As another example, a bicyclist may need to move his or her bike at his or her residence and carrying the bike may be necessary to accomplish that necessary movement (e.g., walking down stairs at an apartment complex). When encountering such obstacles, picking up one's bike can be difficult and/or awkward due to the shape and weight of the bike's frame. Grabbing the frame of the bike may be less than optimal for lifting the bike from the ground because a natural grabbing place on the frame is its top tube. The lack of optimality results from the top tube being further away from the center of gravity than other parts on or areas of the bike. Another possible detriment is that lifting from the top tube may not create sufficient ground clearance for the bicyclist to walk with the bike, where ground clearance is affected by the height of the bicycle in relation to the height of the bicyclist and the height where the bicyclist lifts the bike.

### SUMMARY

A bike transport handle in accordance with an exemplary embodiment of the present disclosure is disclosed. The bike transport handle provides a bicyclist or another person carrying a bike with an improved ability to lift the bike for transporting. The bike transport handle is configured to work in conjunction with a bottle cage on or attached to the bike's seat tube or down tube of the bike's frame.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures.

FIGS. 1-4 are diagrams depicting a bike transport handle in accordance with an exemplary embodiment of the present disclosure; and

FIG. 5 is a diagram illustrating the bike transport handle when connected to a bike in accordance with the present disclosure.

### DETAILED DESCRIPTION

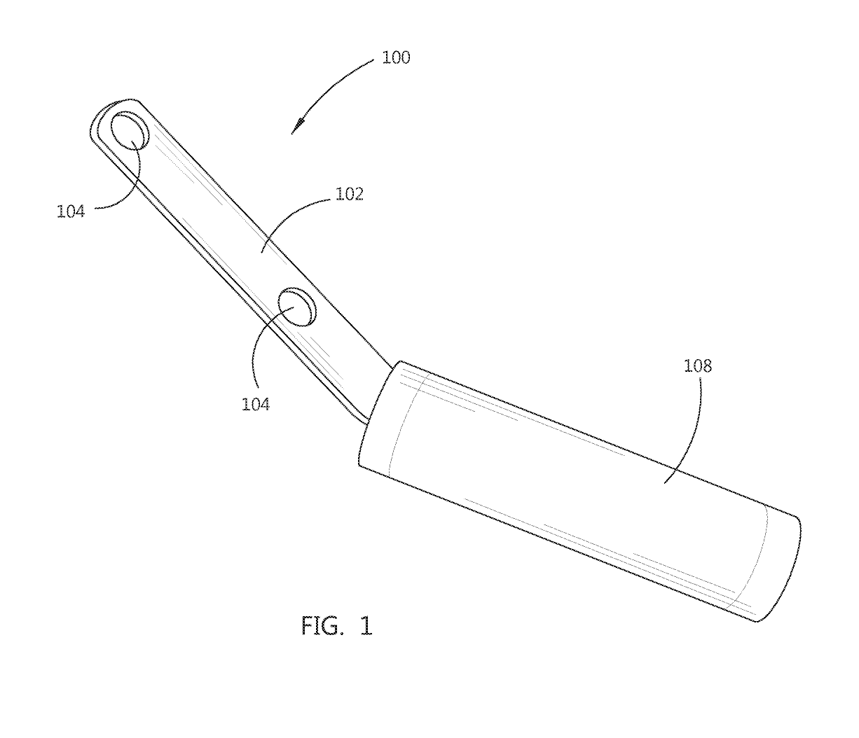

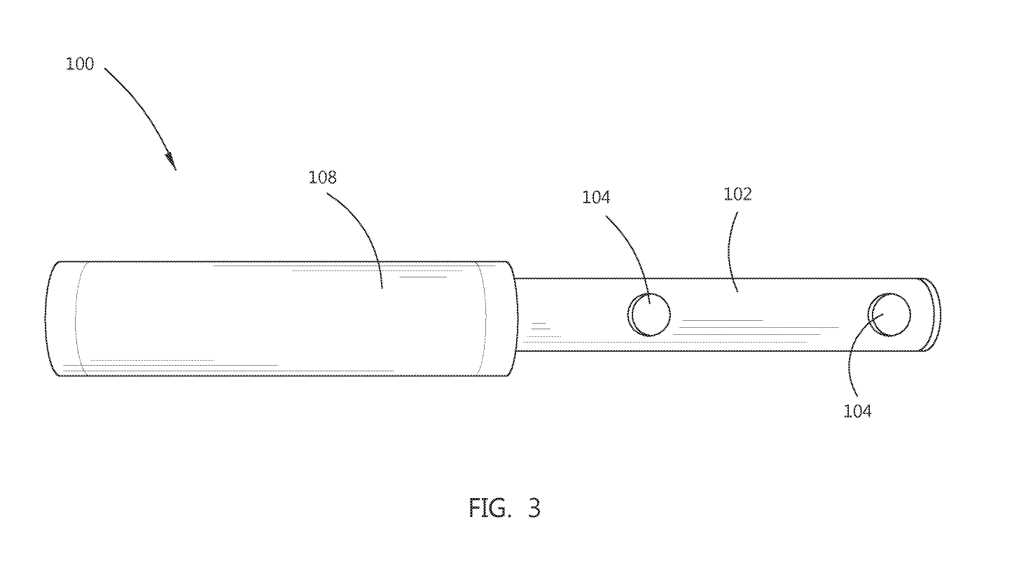

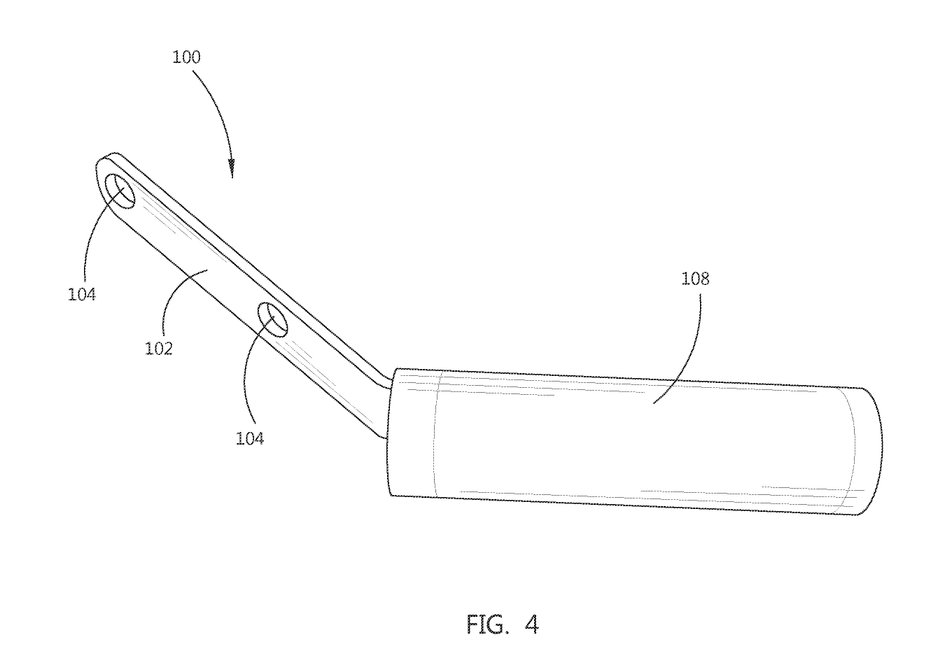

Referring generally to FIGS. 1-4 (FIGS. 1-4), a bike transport handle in accordance with embodiments of the present disclosure is described herein.

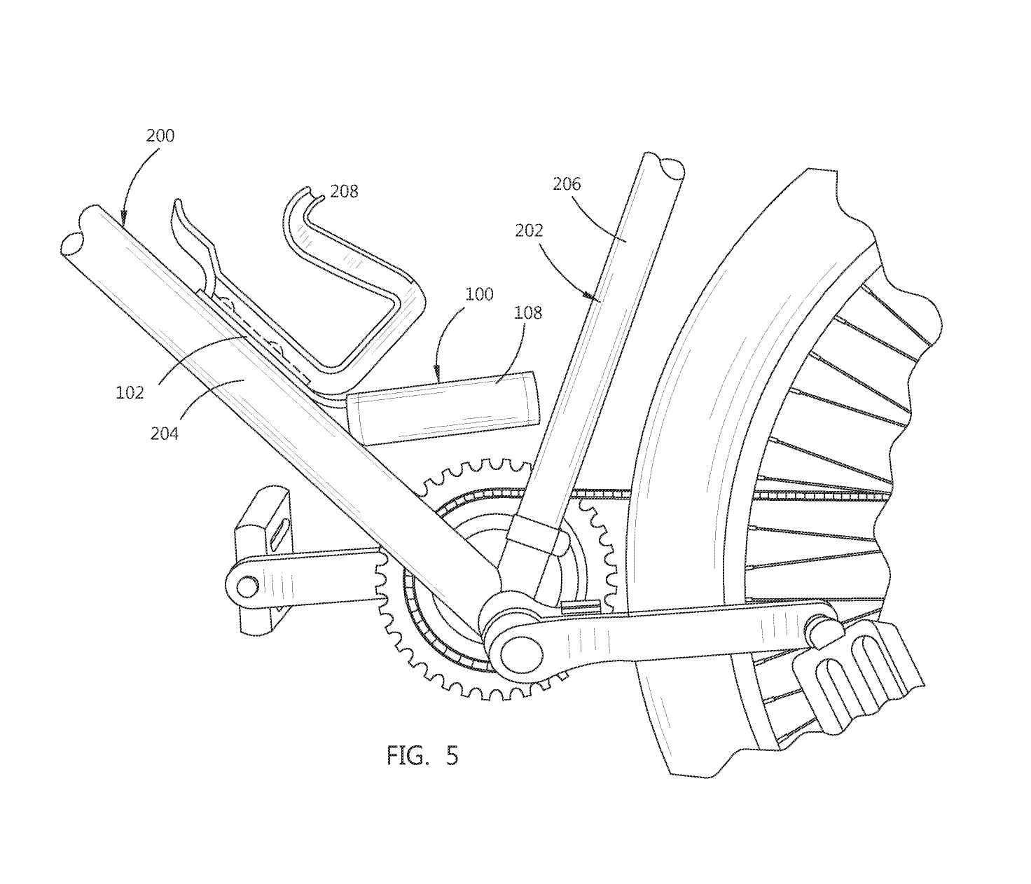

In embodiments, the bike transport handle 100 includes an attachment plate 102. For example, the attachment plate 102 may be a metal plate, such as a cold-rolled steel plate, for promoting sturdiness characteristics of the attachment plate 102 (e.g., without processing such as high temperatures and/or hammering, the material is non-bendable, non-brittle). Further, the attachment plate 102 may be configured for being connected to a frame 202 of a bicycle 200, as shown in FIG. 5 (FIG. 5). For instance, the attachment plate 102 may have one or more apertures 104 formed through it. The location of the apertures 104 of the attachment plate 102 may be established such that they may be aligned with corresponding receptacles formed in the bike frame 202. For example, the apertures 104 may be spaced about 2 to 3 inches apart from each other. Further, the apertures 104 of the attachment plate 102 and the receptacles of the bike frame 202 may be correspondingly sized, shaped and structured, such that when they are aligned, fasteners (e.g., bolts or screws) may be positioned through each aperture 104 and received at least partially within the receptacles for allowing the attachment plate 102 (and thus, the bike transport handle 100) to be secured against (e.g., securely connected to) the bike frame 202 via the fasteners. For example, the receptacles of a bike frame 202 may be threaded for allowing the fasteners to be securely engaged within the receptacles.

In some embodiments, the receptacles formed in the bike frame 202 may be located on the bike frame 202, where fasteners for securing a bottle cage (or bottle holder) 208 to the frame 202 would typically be placed. For instance, the receptacles of the bike frame 202 may be located on and/or formed in the down tube 204 of the bicycle frame 202, in a generally central position between the ends of the down tube 204. As another example, the receptacles of the bike frame 202 may be located on and/or formed in the seat tube 206 of a bike frame 202, in a generally central position between the ends of the seat tube 206. Similar to the down tube 204, the seat tube 206 may also have receptacles formed where fasteners may secure a bottle cage 208 to the frame 202. In this manner, the bike transport handle 100 may be configured for being easily attached to numerous bicycles, where each bicycle already has the receptacles in its frame 202 for receiving fasteners for connecting a bottle cage 208 to the frame 202. For example, a user may simply remove the fasteners that connect the bottle cage 208 to the bike frame 202, align the apertures 104 of the attachment plate 102 with the receptacles of the bike frame 202, align apertures of the bottle cage 208 with the apertures 104 of the attachment plate 102 and the receptacles of the frame 202, re-install the fasteners, by placing them through the apertures of the bottle cage 208, through the apertures 104 of the attachment plate 102, and into the receptacles of the frame 202, and tighten the fasteners within the receptacles for securing the handle 100 and bottle cage 208 to the frame 202.

In implementations, the bike transport handle 100 includes a grasping plate 106. For example, the grasping plate 106 may be a metal plate, such as a cold-rolled steel plate. The grasping plate 106 may be sized and shaped for being grasped by a human hand. The grasping plate 106 may be of similar dimensions as the attachment plate 102. Further, the grasping plate 106 and attachment plate 102 may be formed together or joined such as to form a unitary construction (e.g., a single piece of bent steel). Still further, the grasping plate 106 and attachment plate 102 may form an angle of greater than ninety degrees (e.g., between about 120 and 150 degrees) at the junction area of the grasping plate 106 and attachment plate 102 when the handle 100 connects to the frame 202 along the down tube 204. In the alternative, the grasping plate 106 and attachment plate 102 may form an angle of ninety degrees or greater (e.g., between 90 and 150 degrees) at the junction area of the grasping plate 106 and attachment plate 102 when the handle 100 connects to the frame 202 along the seat tube 206. The angled structures described above allow for compatibility with the angled structure formed by the relative positions of the down tube 204 and seat tube 206 of the bicycle 200, such that when the handle 100 is connected to the frame 202, the grasping plate 106 is oriented in a generally horizontal direction (e.g., parallel to the ground), thereby promoting ease of access and grasping of the grasping plate 106 by a user. Further, the horizontal positioning of the grasping plate 106 of the handle allows for the user's wrist to be at an angle which promotes stable and comfortable transport of the bicycle 200 by a user via the handle 100 when using one hand. As mentioned above, when the receptacles are formed in a generally central location in the down tube 204 (e.g., between the ends of the down tube 204), the handle 100, when connected to the frame 202 via the receptacles, may be established in a proximally central position (e.g., at a balance point, at a center of gravity) of the bike frame 202, such that the bike 200 resists tipping forward or backward when a user grabs the grasping plate 106 of the handle 100 with one hand. Similarly, when the receptacles are formed in a generally central location in the seat tube 206 (e.g., between the ends of the seat tube 206), the handle 100, when connected to the frame 202 via the receptacles, may be established in a proximally central position (e.g., at a balance point, at a center of gravity) of the bike frame 202, such that the bike 200 resists tipping forward or backward when a user grabs the grasping plate 106 of the handle 100 with one hand. Either of these implementations allow a user to more easily transport (e.g., carry) the bike, such as up or down stairs, even when packages or equipment are loaded on the bike.

In embodiments, the bike transport handle 100 may include a grip 108. The grip 108 may be configured to at least substantially encompass (e.g., may be configured for being placed over, against and/or around) the grasping plate 106. For example, the grip 108 may be an elastomeric (e.g., rubber) grip. The grip 108 may be comprised of one or more materials such as rubber, solid foam, leather, wood, metal, acrylic glass, etc. In implementations, the dimensions, material and thickness of the grip may be selected for providing an ergonomic (e.g., padded) gripping surface over the grasping plate 106. In further embodiments, the grip 108 may include a textured surface or textured surface features (e.g., ridges, bumps) for promoting slip-resistant gripping of the grip 108 (and grasping plate 106). In examples, the grip 108 may be configured for being directly engaged against (e.g., adhered to) at least a portion of the grasping plate 106, such as via an adhesive (e.g., glue).

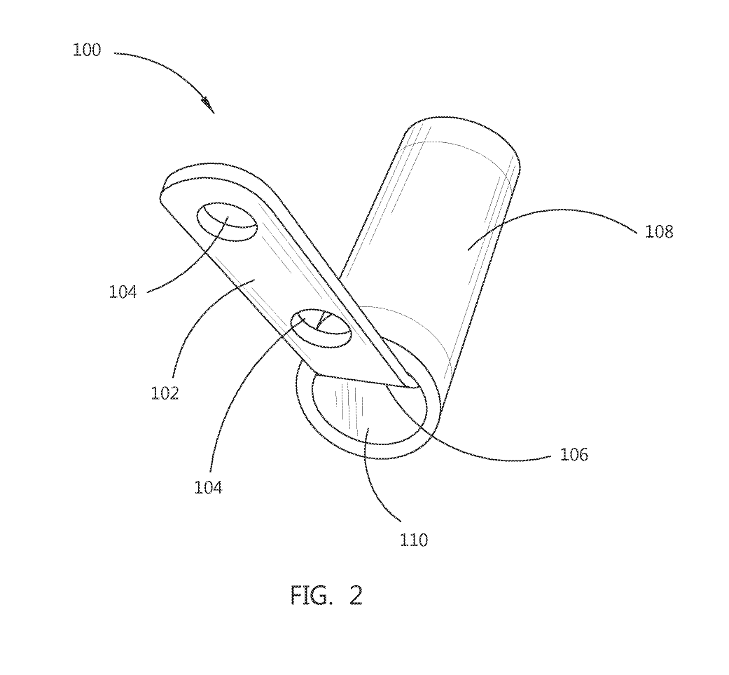

In implementations, the bike transport handle 100 may include a stabilizing portion 110. The stabilizing portion 100 may be positioned between the grip 108 and the grasping plate 106 for promoting stable and/or ergonomic grasping of the bike transport handle 100. For example, as seen in FIG. 2 (FIG. 2), the grip 108 may substantially encompass the grasping plate 106 and the stabilizing portion 110 in a sheath-like manner, such that an inner surface of the grip 108 is engaged against (e.g., adhered to) the top surface of the grasping plate 106, while the stabilizing portion is engaged against (e.g., adhered to) the bottom surface of the grasping plate 106 and an interior surface of the grip 108. Such a configuration provides support for the grasping plate 106, which is supported upon the stabilizing portion 110. Further, if the grip 108 is formed of a deformable material (e.g., solid foam or rubber), such that it forms a deformable sheath around the grasping plate 106, the stabilizing portion 110 may be sized and shaped to substantially fill space formed between the bottom surface of the grasping plate 106 and the grip 108 (e.g., the stabilizing portion 110 has a volume that is enough to create a tight fit between grip 108 and the encompassed combination of the grasping plate 106 and stabilizing portion 110). If the grip 108 is formed of a non-deformable material (e.g., wood, metal, or acrylic glass), the grip 108 may still form a sheath around the grasping plate 106 and the stabilizing portion 110, which is sized and shaped for substantially filling the space formed between the bottom surface of the grasping plate 106 and the grip 108, but a filler, adhesive and/or other binding agent may be used to improve the tightness of the fit.

In implementations, the grasping plate 106 may comprise the stabilizing portion 110 as a unitary structure. In such implementations, the stabilizing portion 110 may be formed (or shaped) out of additional material comprising the grasping plate 106, where the grasping plate 106 is steel or another sturdy material. The stabilizing portion 110 would be positioned between the grip 108 and surface of the grasping plate 106 to or from which the stabilizing portion 110 derives. For example, the grip 108 may substantially encompass the grasping plate 106, including the stabilizing portion 110, in a sheath-like manner, such that an inner surface of the grip 108 is engaged against (e.g., adhered to) the top surface of the grasping plate 106, while the stabilizing portion 110 forms the bottom surface of the grasping plate 106 and engages against (or adheres to) an interior surface of the grip 108. Further, if the grip 108 is formed of a deformable material, such that it forms a deformable sheath around the grasping plate 106, the stabilizing portion 110 may be sized and shaped to substantially fill space formed by the shaping of the grip 108 that acts as a sheath for the grasping plate 106 with its stabilizing portion 110. If the grip 108 is formed of a non-deformable material, the grip 108 may still form a sheath around the grasping plate 106 and stabilizing portion 110.

Thus, as described above, the stabilizing portion 110 may prevent substantial deformation (e.g., sagging) of the grip 108. Further, the stabilizing portion 110 may provide a more padded structure when the handle 100 is grasped by a user, thereby promoting more stable gripping of the handle 100. For instance, the stabilizing portion 110 promotes the prevention of destabilizing (e.g., side-to-side, up-down) movement of the bike 200 when the user grips the grasping plate 106 through the grip 108 to carry the bike 200 via the handle 100. In embodiments, the stabilizing portion 110 may be a multi-piece structure or a unitary structure. For example, the stabilizing portion 110 may be a unitary shaped structure formed of a single half cylinder. As another example, the stabilizing portion 110 may be a multi-piece shaped structure of two quarter cylinders. Further, the stabilizing portion 110 may be formed of any of a number of various materials, such as wood, plastic, fiberglass, acrylic glass, metal, etc.

Although the subject matter has been described in language specific to structural features, it is to be understood that the subject matter defined in the appended claims is not necessarily limited to the specific features described above. Rather, the specific features described above are disclosed as example forms of implementing the claims.

What is claimed is:

1. A bike transport handle for a bike, comprising:
an attachment plate with at least one aperture;
a grasping plate adjoining the attachment plate;
a stabilizing portion connected to the grasping plate; and
a grip at least substantially encompassing the grasping plate and the stabilizing portion, the grasping plate being supported upon the stabilizing portion,
wherein the at least one aperture is configured for receiving a fastener for securely connecting the handle to a frame of the bike proximal to a center of gravity located on the bike for promoting stable transport of the bike by a user via grasping of the handle.

2. The bike transport handle in claim 1, wherein the attachment plate and grasping plate are made from cold-rolled steel.

3. The bike transport handle in claim 1, wherein the grasping plate adjoining the attachment plate forms an angle of at least ninety degrees.

4. The bike transport handle in claim 1, wherein the grip is made from a deformable material.

5. The bike transport handle in claim 1, wherein the grip is made from a non-deformable material.

6. A bike transport handle for a bike, comprising:
an attachment plate with at least one aperture;
a grasping plate adjoining the attachment plate;
a stabilizing portion formed out of the grasping plate; and
a grip at least substantially encompassing the grasping plate and the stabilizing portion,
wherein the at least one aperture is configured for receiving a fastener for securely connecting the handle to a frame of the bike proximal to a center of gravity located on the bike for promoting stable transport of the bike by a user via grasping of the handle.

7. The bike transport handle in claim 7, wherein the attachment plate is made from cold-rolled steel.

8. The bike transport handle in claim 7, wherein the grasping plate adjoining the attachment plate forms an angle of at least ninety degrees.

9. The bike transport handle in claim 7, wherein the grip is made from a deformable material.

10. The bike transport handle in claim 1, wherein the grip is made from a non-deformable material.

11. A bike transport handle for a bike, comprising:
an attachment plate with at least two apertures;
a grasping plate adjoining the attachment plate;
a stabilizing portion formed out of the grasping plate; and
a deformable grip at least substantially encompassing the grasping plate and the stabilizing portion,
wherein the at least two apertures are each configured for receiving a fastener for securely connecting the handle to a down tube on a frame of the bike proximal to a center of gravity located on the bike for promoting stable transport of the bike by a user via grasping of the handle.

12. The bike transport handle in claim 11, wherein the attachment plate is made from cold-rolled steel.

13. The bike transport handle in claim 11, wherein the grasping plate adjoining the attachment plate forms an angle of greater than ninety degrees.

14. The bike transport handle in claim 11, wherein the deformable grip is made from rubber.

15. The bike transport handle in claim 11, wherein the deformable grip is made from solid foam.
